(19) United States
(12) Patent Application Publication
(10) Pub. No.: US 2026/0203342 A1
(43) Pub. Date: Jul. 16, 2026

(54) METHOD AND APPARATUS WITH IMAGE RETRIEVAL

(71) Applicant: Samsung Electronics Co., Ltd., Suwon-si (KR)

(72) Inventors: Ilwi YUN, Suwon-si (KR); Seongeun KIM, Suwon-si (KR); Seungin PARK, Suwon-si (KR); Dongwook LEE, Suwon-si (KR); Wonjun CHOI, Suwon-si (KR); Sunjun HWANG, Suwon-si (KR)

(73) Assignee: Samsung Electronics Co., Ltd., Suwon-si (KR)

(21) Appl. No.: 19/388,275

(22) Filed: Nov. 13, 2025

(30) Foreign Application Priority Data
Jan. 13, 2025 (KR) 10-2025-0005058

(51) Int. Cl. G06F 16/41; G06F 16/435

(52) U.S. Cl. CPC G06F 16/41; G06F 16/435

(57) ABSTRACT

A processor-implemented method including generating a text query based on an image query by inputting the image query to a trained first model, obtaining, from a database, one or more images as a first retrieval result for the image query and one or more texts as a second retrieval result for the text query, generating a multimodal score for a candidate image set by inputting, to a trained second model, the image query, the text query, and the candidate image set determined based on the first retrieval result and the second retrieval result, and determining one or more target images from the candidate image set based on the multimodal score for the candidate image set.

### CROSS-REFERENCE TO RELATED APPLICATIONS

This application claims the benefit under 35 USC § 119(a) of Korean Patent Application No. 10-2025-0005058, filed on January 13, 2025, in the Korean Intellectual Property Office, the entire disclosure of which is incorporated herein by reference for all purposes.

### BACKGROUND

### 1. Field

The following description relates to a method and an apparatus with image retrieval, and more particularly, to a method of retrieving an image based on an image query and a text query based on a multimodal foundation model and an electronic device for performing the method.

### 2. Description of Related Art

A foundation model (FM) may be a large deep learning neural network trained with vast datasets (e.g., including billions of parameters) and may be applied to various downstream tasks. The development of faster and more cost-effective artificial intelligence (AI) models based on the FM has led to significant advances in computer vision, natural language processing, voice analysis, and other various fields. Specifically, a multimodal FM that is simultaneously trained by multiple modalities may be effectively used for generating text, audio, an image, a video, and three-dimensional (3D) content.

A large language model (LLM) is an AI technology for supporting an intelligent chatbot and other natural language processing applications, and may generate a result for tasks, such as a response to a user's inquiry, language translation, and sentence completion. Known issues with the LLM may include hallucination (i.e., providing false answers), generating a response from unreliable sources, and providing outdated or generic information. Retrieval- augmented generation (RAG) is a process of referring to a reliable external knowledge base of a training data source of the LLM before generating a response. Firstly, relevant documents may be retrieved from external data sources in various formats, such as an application program interface (API), a database, or a document repository, based on a user query. The LLM may generate a final response taking the retrieved documents as inputs with the user query.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a text query based on an image query by inputting the image query to a trained first model, obtaining, from a database, one or more images as a first retrieval result for the image query and one or more texts as a second retrieval result for the text query, generating a multimodal score for a candidate image set by inputting, to a trained second model, the image query, the text query, and the candidate image set determined based on the first retrieval result and the second retrieval result, and determining one or more target images from the candidate image set based on the multimodal score for the candidate image set.

The database may include an image database and a text database and the text database may include texts respectively matched with images included in the image database.

The obtaining of the one or more images may include generating a first embedding vector by performing embedding on the image query and a second embedding vector by performing embedding on the text query, obtaining the first retrieval result based on a first comparison between the first embedding vector and embedding vectors indexed to the images included in the database, and obtaining the second retrieval result based on a second comparison between the second embedding vector and embedding vectors indexed to the texts included in the database.

The obtaining of the one or more images as the first retrieval result may include determining first scores of the images by comparing the first embedding vector with the embedding vectors indexed to the images included in the database and obtaining the one or more images as the first retrieval result based on respective first scores of the images satisfying a defined condition.

The obtaining of the one or more texts as the second retrieval result may include determining second scores of the texts by comparing the second embedding vector with the embedding vectors indexed to the texts included in the database and obtaining the one or more texts satisfying a defined condition as the second retrieval result, based on the second scores of the texts.

The candidate image may include the one or more images obtained as the first retrieval result and one or more images matched with the one or more texts obtained as the second retrieval result.

The trained second model may be pre-trained to output a multimodal score for each candidate image based on the image query, the text query, and multimodal feature information on each candidate image of the candidate image set.

The determining of the one or more target images from the candidate image set may include determining a defined number of candidate images with highest multimodal scores as the one or more target images from the candidate image set.

The method may include obtaining an image database, inputting images included in the image database to the trained first model to obtain texts, generating an embedding vector as an index for each of the texts by performing embedding on the texts, and generating a text database including the texts to which corresponding embedding vectors are respectively indexed.

The method may include generating a response to the image query by using at least a portion of the one or more target images.

In a general aspect, here is provided a non-transitory computer-readable storage medium that stores one or more programs including instructions, and the instructions, when executed individually or collectively by at least one processor of an electronic device, cause the electronic device to generate a text query based on an image query by inputting the image query to a trained first model, obtain, from a database, one or more images as a first retrieval result for the image query and one or more texts as a second retrieval result for the text query, generate a multimodal score for a candidate image set by inputting, to a trained second model, the image query, the text query, and the candidate image set determined based on the first retrieval result and the second retrieval result, and determine one or more target images from the candidate image set based on the multimodal score for the candidate image set.

In a general aspect, here is provided an electronic device including at least one processor, memory including one or more storage media storing instructions, and the instructions, when executed individually or collectively by the at least one processor, cause the electronic device to perform generating a text query based on an image query by inputting the image query to a trained first model, obtaining, from a database, one or more images as a first retrieval result for the image query and one or more texts as a second retrieval result for the text query, generating a multimodal score for a candidate image set by inputting, to a trained second model, the image query, the text query, and the candidate image set determined based on the first retrieval result and the second retrieval result, and determining one or more target images from the candidate image set based on the multimodal score for the candidate image set.

The database may include an image database and a text database and the text database may include texts respectively matched with images included in the image database.

The obtaining of the one or more images as the first retrieval result may include generating a first embedding vector by performing embedding on the image query and a second embedding vector by performing embedding on the text query, obtaining the first retrieval result based on a first comparison between the first embedding vector and embedding vectors indexed to the images included in the database, and obtaining the second retrieval result based on a second comparison between the second embedding vector and embedding vectors indexed to the texts included in the database.

The obtaining of the one or more images as the first retrieval result may include determining first scores of the images by comparing the first embedding vector with the embedding vectors indexed to the images included in the database and obtaining the one or more images as the first retrieval result based on respective first scores of the images satisfying a defined condition.

The obtaining of the one or more texts as the second retrieval result may include determining second scores of the texts by comparing the second embedding vector with the embedding vectors indexed to the texts included in the database and obtaining the one or more texts satisfying a defined condition as the second retrieval result, based on the second scores of the texts.

The candidate image set may include the one or more images obtained as the first retrieval result and one or more images matched with the one or more texts obtained as the second retrieval result.

The trained second model may be pre-trained to output a multimodal score for each candidate image based on the image query, the text query, and multimodal feature information on each candidate image of the candidate image set.

The determining of the one or more target images from the candidate image set may include determining a defined number of candidate images with highest multimodal scores as the one or more target images from the candidate image set.

The instructions, when executed individually or collectively by the at least one processor, further cause the electronic device to perform generating a response to the image query by using at least a portion of the one or more target images.

Other features and aspects will be apparent from the following detailed description, the drawings, and the claims.

### BRIEF DESCRIPTION OF THE DRAWINGS

FIG. 1 illustrates an example system with image retrieval system according to one or more embodiments.

FIG. 2 illustrates an example electronic device with a database including retrieval target data according to one or more embodiments.

FIG. 3 illustrates an example electronic device according to one or more embodiments.

FIG. 4 illustrates an example method with image retrieval according to one or more embodiments.

FIG. 5 illustrates an example method with obtaining a multimodal retrieval result according to one or more embodiments.

FIG. 6 illustrates an example method with database establishment according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

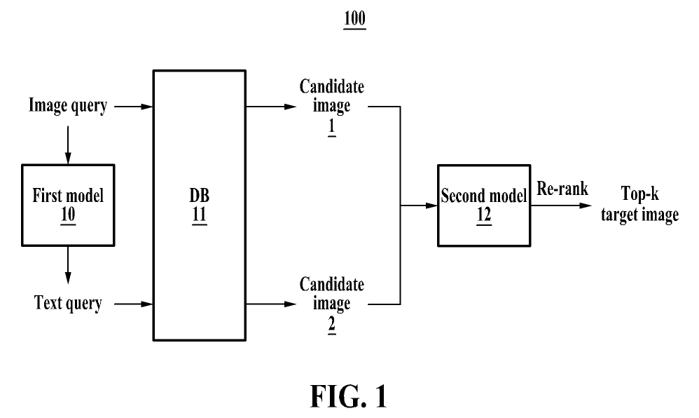

FIG. 1 illustrates an example system with image retrieval system according to one or more embodiments.

Referring to FIG. 1, in a non-limiting example, an image retrieval system (hereinafter, also referred to as the "system") 100 may be a system for retrieval-augmented generation (RAG). The system 100 may include a database 11 for retrieving a relevant document file based on a user's query.

A large language model (LLM) is an AI technology for supporting an intelligent chatbot and other natural language processing applications, and may generate a result for tasks, such as a response to a user's inquiry, language translation, and sentence completion. Known issues with the LLM may include hallucinations that provide false answers, generating a response from unreliable sources, and providing outdated or generic information. The RAG may be a process of referring to a reliable external knowledge base of a training data source of the LLM before generating a response. Firstly, a relevant document file may be retrieved from external data sources in various formats, such as an application program interface (API), a database, or a document repository, based on a user query. The LLM may generate a final response taking the retrieved document file as an input with the user query.

The database 11 may include document files. The document file may correspond to a document file including an image or text or a multimodal document file including different data types. The data types may include, for example, at least one of a first type (e.g., text), a second type (e.g., an image), a third type (e.g., a table), or a fourth type (e.g., a graph). Hereinafter, a method of retrieving an image (or an image file) as a document file related to the user query is described.

In an example, at least a portion of the system 100 may be implemented as an internal model of the LLM. The database 11 may be integrated into (or included in) the LLM or an LLM server. The LLM (or the LLM server) may include, for example, a built-in model for image retrieval. The LLM may retrieve an image from the database 11 via the built-in model for image retrieval. For example, when image data is relatively static and domain-specific, the LLM may cache the image data in the database 11 and may rapidly retrieve it. The database 11 may be integrated into the LLM server as a retrieval library. The LLM may generate a final response using a retrieved image from the database 11 together with the user query.

In an example, at least a portion of the system 100 may be implemented as an external data source of the LLM. For example, the system 100 may include an electronic device (e.g., a server or cloud-based document repository) including the database 11. For example, the LLM may retrieve an image from the system 100 for the user query via an external API. The external API may provide a standard interface (e.g., representational state transfer (REST), RESTful, or a Google remote procedure call (gRPC) protocol) and may allow the LLM to interact with the system 100 and obtain a retrieval result. The LLM may retrieve an image related to the user query from the database 11 by calling the external API. The LLM may generate a final response using a retrieved image from the database 11 together with the user query.

In an example, the system 100 may include a trained first model 10. For example, the first model 10 may be included in the LLM or the LLM server. For example, the first model 10 may be included in an electronic device implemented as an external data source of the LLM.

The first model 10 may represent a multimodal foundation model (MMFM) trained with multiple modalities including at least text and an image. The first model 10 may represent an artificial intelligence (AI) neural network (or a generative model) for generating new data based on a user input and may include a multimodal generative model (e.g., a large multimodal model (LMM)).

The system 100 may include an AI framework (not shown). The AI framework may receive a user input. The AI framework may tune and control one or more components required to perform an operation that matches an intent of the user based on the user input (e.g., a query of the user). For example, the AI framework may include a prompt design component, an application programming interfaces (APIs)/plugins management component, and a refiner component.

In the system 100, the received user input may be transmitted to the prompt design component. The prompt design component may be used to generate a prompt suitable as an input to the first model 10, based on the user input. The prompt design component may be an AI component using a machine learning algorithm or a neural network. The prompt design component may generate an improved prompt by learning over time. The prompt design component may provide the generated prompt to the first model 10.

The APIs/plugins management component may communicate with an external information source based on a request for additional information when the user input is transmitted to the first model 10. The APIs/plugins management component may establish a communication channel to communicate with the outside of the system 100 via an API. The APIs/plugins management component may access various data sources via the communication channel. For example, the APIs/plugins management component may be used to send a request to another component (e.g., an application/service component) that provides feedback (or a response) according to the prompt. The obtained information may be used to generate a prompt by the prompt design component together with the user input or may be used as an input to the first model 10.

The refiner component may at least partially tune (or adjust) (or change) a result obtained (or output) from the first model 10. For example, the refiner component may determine a relevance (e.g., a score) between an output (e.g., content) of the first model 10 and the user input. For example, the refiner component may determine whether the output includes biased information (e.g., selective information). The refiner component may determine a matching level between the output of the first model 10 and the user input (e.g., the intent of the user input). When the refiner component determines that the output of the first model 10 does not correspond to the user input, the refiner component may modify the output to correspond to the user input.

The system 100 may obtain a user query (e.g., a prompt and/or a natural language query). For example, the system 100 may receive the user query from a user terminal (not shown), such as a smartphone, a tablet, a laptop, or a personal computer (PC). The user query may also be referred to as a user request and may include, for example, natural language text, an image, a video, audio, or a combination thereof.

For example, when the user query includes an image query, the system 100 may retrieve an image (or an image file) as a document file related to the image query.

The system 100 may perform image-to-image retrieval on the database 11 using the image query. The system 100 may obtain a candidate image 1 similar to the image query from the database 11.

Next, the system 100 may obtain a text query corresponding to the image query output by the first model 10 by inputting the image query to the trained first model 10.

For example, the first model 10 may generate a text query describing (or explaining, summarizing, captioning, or interpreting) the image query. For example, the system 100 may input the image query and a determined prompt to the first model 10. The determined prompt may indicate an instruction (or a command) that causes the first model 10 to generate a text query describing the image query.

The system 100 may perform text-to-text retrieval on the database 11 using the text query corresponding to the image query. The system 100 may obtain candidate text similar to the text query from the database 11.

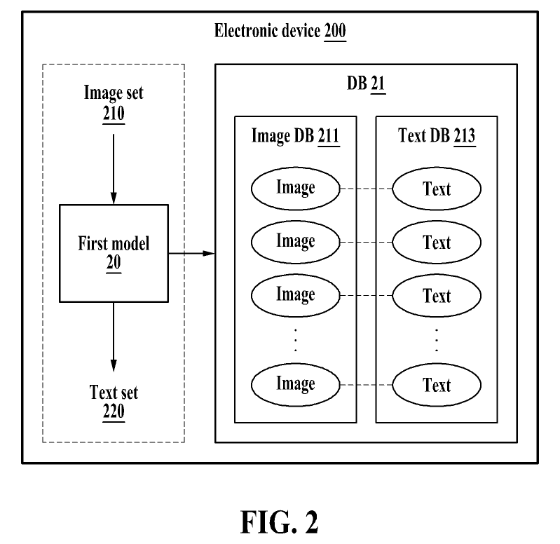

In an example, the database 11 may include texts in addition to images. The texts included in the database 11 may respectively correspond to images included in the database 11. Each text included in the database 11 may have a one-to-one (or one-to-many or many-to-one) correspondence with each image included in the database 11. For example, the database 11 may include one or more pairs of data including an image and text. The database 11 is described in greater detail below with reference to FIG. 2.

The system 100 may obtain a candidate image 2 which is matched with the candidate text similar to the text query from the database 11. The candidate image 2 may be an image paired with the candidate text in the database 11.

The candidate image 1 and the candidate image 2 may include a plurality of candidate images. The candidate image 1 may include top "a" candidate images that are most similar to the image query from the images of the database 11. The candidate image 2 may include top "b" candidate images that are most similar to the text query from the images of the database 11. In some cases, the candidate image 1 and the candidate image 2 may include a partially overlapping candidate image.

The system 100 may re-rank the candidate image 1 obtained for the image query from the database 11 and the candidate image 2 obtained for the text query, according to a level of similarity to the image query and/or the text query. The system 100 may determine top K target images that are most similar to the image query and/or the text query from the candidate image 1 and the candidate image 2.

In an example, the system 100 may include a trained second model 12. For example, the second model 12 may be included in the LLM or the LLM server. For example, the second model 12 may be included in an electronic device implemented as an external data source of the LLM.

The second model 12 may be pre-trained to generate and output multimodal scores indicating a similarity (or relevance) between input data of multiple modalities including at least text and an image. For example, the second model 12 may be pre-trained to output multimodal scores for the candidate images 1 and 2 in response to inputs of image query, the text query, and the candidate images 1 and 2. In an example, the second model 12 may be pre-trained to output multimodal scores for the candidate images 1 and 2 based on the image query, the text query, and multimodal feature information on the candidate images 1 and 2. The multimodal scores for the candidate images 1 and 2 may be a result of quantifying the similarity (or relevance) between the query (in other words, the image query and the text query) and the candidate images 1 and 2 using the multimodal feature information.

The multimodal feature information may be a multimodal representation generated by combining feature information on multiple modalities (e.g., an image or text). The multimodal feature information may include a feature vector (e.g., an embedding vector).

The system 100 may re-rank the candidate images 1 and 2 according to the multimodal scores output by the second model 12. The system 100 may determine top K target images with highest multimodal scores from the candidate images 1 and 2.

Herein, the candidate images 1 and 2 obtained by database-based retrieval corresponding to each modality may reflect a retrieval advantage of each modality. For example, the candidate image 1 obtained by image-based image retrieval may reflect low-level semantic information of the image query and this may be a retrieval result focused on a visual feature, such as a color, texture, a shape, and an edge. The candidate image 2 obtained by text-based text retrieval may reflect high-level semantic information of the image query and this may be a retrieval result focused on a high-dimensional feature that may be described by text, such as a relation between objects in the image or contextual meaning. Accordingly, the system 100 may contribute to improving a final retrieval result through the returned candidate images 1 and 2 by combining the advantages of each modality.

FIG. 2 illustrates an example electronic device with a database including retrieval target data according to one or more embodiments.

Referring to FIG. 2, in a non-limiting example, an electronic device 200 may include a trained first model (hereinafter, also referred to as the first model) 20 and a database 21. For example, the first model 20 may be the first model 10 of FIG. 1. The first model 20 may indicate a multimodal FM trained with multiple modalities including at least text and images.

For example, the electronic device 200 may be various computing devices such as a high performance computer (HPC), a server computer, a desktop, or a workstation.

The electronic device 200 may obtain an image set 210 and the image set 210 may include a plurality of images.

In an example, the image set 210 may include images and an embedding vector indexed to each image. The electronic device 200 may store, in an image database 211, the images to which the embedding vectors are indexed.

In an example, the electronic device 200 may generate embedding vectors corresponding to the images included in the image set 210 by performing embedding on the images. The embedding may be an operation of converting a given input (e.g., an image) into a number (e.g., a vector). The embedding vectors may correspond to vectors representing each of the images as numbers. The electronic device 200 may determine an index for each of the images based on the generated embedding vector. The determination may include generating (or indexing an embedding vector on each of the images) the index for each of the images. The electronic device 200 may store, in the image database 211, the images to which the embedding vectors are indexed.

The electronic device 200 may generate a text set 220 by inputting each image included in the image set 210 to the first model 20. The electronic device 200 may input images in the image set 210 to the first model 20 to obtain texts respectively matched with the images output by the first model 20. The texts of the text set 220 may respectively correspond to the images of the image set 210. Each text of the text set 220 may describe (i.e., explain, summarize, caption, or interpret) each image of the image set 210. The electronic device 200 may store the text set 220 in a text database 213. This storing may be construed as building the text database 213 based on the texts obtained from the first model 20. For example, the electronic device 200 may store data (e.g., an identifier) indicating a matching relationship (or correlation) between each image of the image set 210 and each text of the test set 220.

In an example, the electronic device 200 may generate embedding vectors corresponding to the texts of the text set 220 output by the first model 20 by performing embedding on the texts. The embedding vectors may correspond to vectors representing each of the texts as numbers, respectively. The electronic device 200 may determine, generate, or index (based on an embedding vector on each of the texts) an index for each of the texts based on the generated embedding vector. The electronic device 200 may store, in the text database 213, the texts to which the embedding vectors are indexed.

A database 21 of the electronic device 200 may include the image database 211 and the text database 213. The database 21 may include the image database 211 and the text database 213 generated based on the image database 211.

In an example, the database 11 of the image retrieval system 100 of FIG. 1 may represent the database 21.

In an example, the electronic device 200 may update the database 21. The electronic device 200 may asynchronously update the images of the image database 211 to maintain the latest information. The electronic device 200 may update an embedding vector for a new image. The electronic device 200 may update text that describes and matches the new image to the text database 213 using the first model 20. The electronic device 200 may update an embedding vector for the text matched with the new image.

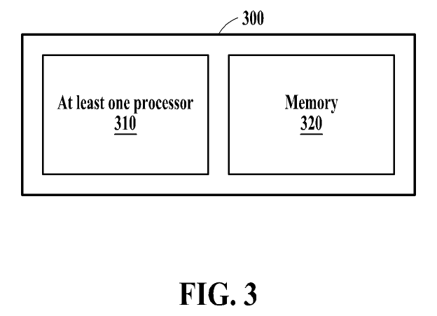

FIG. 3 illustrates an example electronic device according to one or more embodiments.

Referring to FIG. 3, in a non-limiting example, an electronic device 300 may include at least one processor (hereinafter, also referred to as a processor) 310 including a processing circuitry and a memory 320 including one or more storage media storing instructions. When the instructions are individually or collectively executed by the processor 310, the instructions may cause the electronic device 300 to perform at least a portion of the operations described herein with reference to FIGS. 1 to 6. For example, internal components of the electronic device 200 of FIG. 2 may be represented by the components illustrated with respect to the electronic device 300 of FIG. 3.

The electronic device 300 may include a communication unit (not shown) connected to the processor 310 and the memory 320 to transmit and receive data. The communication unit may be connected to other external devices to transmit and receive data. Hereinafter, the expression transmit and receive "A" may refer to transmit and receive "information or data indicating A".

The communication unit may be implemented by a circuitry in the electronic device 300. For example, the communication unit may include an internal bus and an external bus. In another example, the communication unit may be an element to connect the electronic device 300 to an external device. The communication unit may be an interface. The communication unit may receive data from an external device and may transmit the data to the processor 310 and the memory 320.

The memory 320 may include computer-readable instructions. The processor 310 may be configured to execute computer-readable instructions, such as those stored in the memory 320, and through execution of the computer-readable instructions, the processor 310 is configured to perform one or more, or any combination, of the operations and/or methods described herein. The memory 320 may be a volatile or nonvolatile memory, such as random access memory (RAM), dynamic RAM (DRAM), static RAM (SRAM), non-volatile RAM (NVRAM), persistent memory (PMEM), magneto-resistive random memory (MRAM), high bandwidth memory (HBM), and 3DXPoint.

The processor 310 may be configured to execute programs or applications to configure the processor 310 to control the electronic apparatus 300 to perform one or more or all operations and/or methods involving image retrieval, and may include any one or a combination of two or more of, for example, microprocessor, a central processing unit (CPU), a graphics processing unit (GPU), a processor core, a multi-core processor, a multiprocessor, an application-specific integrated circuit (ASIC), and a field-programmable gate array (FPGA), but the processor 310 is not limited to the above-described examples.

In an example, the processor 310 may control other components (e.g., a hardware or software component) of the electronic device 300 and may perform various data processing or computations. As at least a portion of data processing or computation, the processor 310 may store an instruction or data received from another component (e.g., the communication unit) in at least a portion of the memory 320, may process the instruction or data stored in the memory 320, and may store resulting data in the memory 320. The operations performed by the processor 310 may be substantially the same as the operations of the electronic device 300.

The electronic device 300 may be connected to an external memory via the communication unit. For example, the external memory may include at least one volatile memory, non-volatile memory, RAM, flash memory, a hard disk drive, and an optical disk drive. The external memory may store a set of instructions (e.g., software) to operate the electronic device 300. The set of instructions to operate the electronic device 300 may be executed by the processor 310.

In an example, the first model 10 described with reference to FIG. 1 and/or an AI framework may be included in the electronic device 300. For example, the first model 10 and/or the AI framework may be included in processing elements which may include processing circuitry in the electronic device 300. For example, processing elements including the processing circuitry may be operatively coupled to at least one processor (e.g., the processor 310) of the electronic device 300.

In an example, the memory 320 may store a first model (e.g., the first model 20 of FIG. 2 or the first model 10 of FIG. 1), a second model (e.g., the second model 12), and/or a database (e.g., the database 21). Depending on the implementation, the database may be stored in the memory 320 (or the first memory) and the first model and the second model may be stored in another memory (or the second memory). The first model and the second model may be stored in different memories and these examples are not limited to the present disclosure.

The processor 310 may obtain an image set (e.g., the image set 210 of FIG. 2) and the image set may include a plurality of images.

In an example, the image set obtained by the processor 310 may include images and an embedding vector indexed to each image. The electronic device 300 may store, in an image database (e.g., the image database 211), the images to which the embedding vectors are indexed.

In an example, the electronic device 300 may include a vision encoder (or a vector encoder based on an image model). The memory 320 may store the vision encoder (e.g., a weight of the vision encoder and related data). The vision encoder may be trained to extract feature information (e.g., a shape, text, a pattern, etc.) by processing an input image and convert the extracted feature information into an embedding vector of a high-dimensional space.

The processor 310 may generate embedding vectors corresponding to the images included in the image set by performing embedding on the images using the vision encoder. The processor 310 may determine an index for each of the images based on the generated embedding vector. The determining of the index may include generating the index or indexing an embedding vector on each of the images. The processor 310 may store, in the image database, the images to which the embedding vectors are indexed.

The processor 310 may generate a text set (e.g., the text set 220) by inputting each image included in an image set (e.g., the image set 210) to the first model. The processor 310 may input images in the image set to the first model to obtain texts respectively matched with the images output by the first model.

In an example, the electronic device 300 may include a text encoder (or a language model-based vector encoder). The memory 320 may store the text encoder (e.g., a weight of the text encoder and related data). The text encoder may be trained to extract feature information (e.g., a grammatical structure, a relation between words, semantic information, etc.) by processing the input text and convert the extracted feature information into a high-dimensional embedding vector. The feature information extracted by the text encoder may be used for a task, such as topic classification, sentiment analysis, and summary generation.

The processor 310 may generate embedding vectors corresponding to the texts of the text set output by the first model by performing embedding on the texts using the text encoder. The processor 310 may determine an index for each of the texts based on the generated embedding vector. The processor 310 may store, in the text database, the texts to which the embedding vectors are indexed.

In an example, the electronic device 300 may include a multimodal model trained to extract feature information by processing data of an arbitrary input modality (e.g., an image or text) and convert the extracted feature information into an embedding vector of a high-dimensional space. The memory 320 may store the multimodal model. For example, the processor 310 may generate the embedding vectors corresponding to the images of the image set by performing embedding on the images using the multimodal model. For example, the processor 310 may generate the embedding vectors corresponding to the texts output by the first model by performing embedding on the texts using the multimodal model. In other words, for data of an arbitrary modality, the processor 310 may generate the embedding vector by performing embedding using the multimodal model as well as an encoder (e.g., the vision encoder, the text encoder) of the corresponding modality.

The processor 310 may update the database. The processor 310 may asynchronously update the images of the image database to maintain latest information. The processor 310 may update the embedding vector for a new image. The processor 310 may update text that matches and describes the new image using the first model. The processor 310 may update the embedding vector for the text matched with the new image.

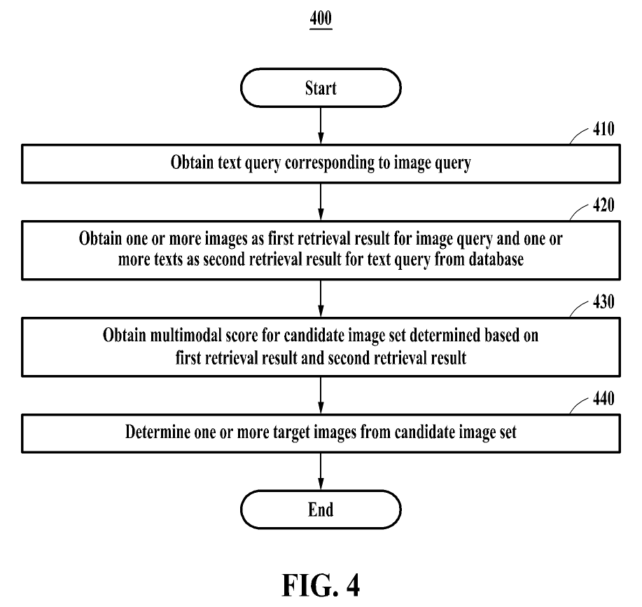

FIG. 4 illustrates an example method with image retrieval according to one or more embodiments.

Referring to FIG. 4, in a non-limiting example, method 400 may include operations 410 to 430 which, as described below, may be performed by an electronic device (e.g., the electronic device 300 of FIG. 3 as embodied by the electronic device 200 of FIG. 2). That is, the electronic device that performs the method 400 may include at least some of the components of the electronic device 300 described above with reference to FIG. 3. For example, the electronic device may include at least one processor (e.g., the at least one processor 310 of FIG. 3) including a processing circuitry. The electronic device may include a memory (e.g., the memory 320 of FIG. 3) including one or more storage media storing instructions. Furthermore, electronic device may include a trained first model (e.g., the first model 10 of FIG. 1 or the first model 20 of FIG. 2). The electronic device may also include a trained second model (e.g., the second model 12 of FIG. 1).

The electronic device may obtain a user query (e.g., a prompt and/or a natural language query). For example, the electronic device may receive the user query from a user terminal, such as a smartphone, a tablet, a laptop, or a PC. The user query may also be referred to as a user request and may include, for example, natural language text, an image, a video, audio, or a combination thereof.

The user query may include an image query. The electronic device may retrieve an image (or an image file) as a document file related to the image query.

In an example, in operation 410, the electronic device (e.g., electronic device 300) may obtain a text query corresponding to the image query output by the trained first model by inputting the image query to the trained first model.

The electronic device may generate a text query that describes (or explains, summarizes, captions, or interprets) the image query using the first model. The text query may represent one or more words related to an object in the image query or a feature. The text query may be a phrase, a clause, or multiple sentences.

In an example, in operation 420, the electronic device (e.g., electronic device 300) may obtain one or more images as a first retrieval result for the image query and one or more texts as a second retrieval result for the text query from a database (e.g., the database 11 of FIG. 1 or the database 21 of FIG. 2).

Referring back to FIG. 2, the database may include an image database (e.g., the image database 211 of FIG. 2) and a text database (e.g., the text database 213 of FIG. 2).

The electronic device may perform image-to-image retrieval on the image database using the image query. The electronic device may obtain, from the image database, one or more images (e.g., the candidate image 1 of FIG. 1) similar to the image query as the first retrieval result.

The electronic device may perform text-to-text retrieval on the text database using the text query corresponding to the image query. The electronic device may obtain, from the text database, one or more texts similar to the text query as the second retrieval result.

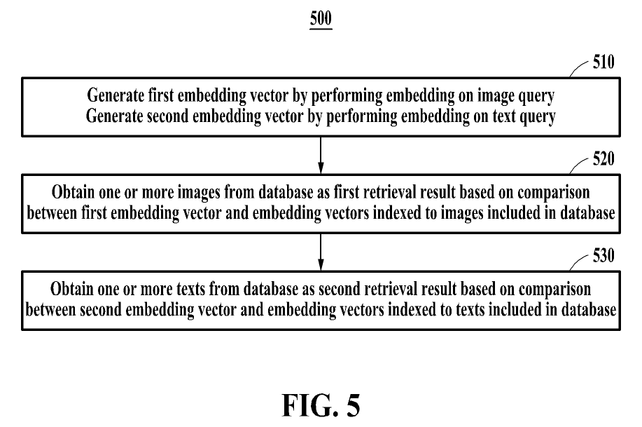

The method of obtaining the first retrieval result and the second retrieval result is described in greater detail below with reference to FIG. 5.

Referring back to FIG. 4, in an example, in operation 430, the electronic device (e.g., electronic device 300) may obtain multimodal scores for a candidate image set output by the trained second model by inputting the image query, the text query, and the candidate image set determined based on the first and second retrieval results to the trained second model.

The candidate image set may include one or more images (e.g., the candidate image 1 of FIG. 1) obtained as the first retrieval result and one or more images (e.g., the candidate image 2 of FIG. 1) matched with one or more texts obtained as the second retrieval result.

The one or more images matched with the one or more texts obtained as the second retrieval result may indicate one or more images in the image database respectively paired with the one or more texts in the text database.

As described above with reference to FIG. 1, the second model may be pre-trained to output a multimodal score for each candidate image based on multimodal feature information on each candidate image of the candidate image set, the image query, and the text query.

The multimodal feature information may be a multimodal representation generated by combining feature information on multiple modalities (e.g., an image or text). The multimodal feature information may include a feature vector (e.g., an embedding vector).

In an example, the second model may include a vision encoder and a text encoder. The second model may generate an embedding vector for each candidate image of the candidate image set and the image query through the vision encoder and may generate an embedding vector for the text query. The second model may generate multimodal feature information corresponding to each candidate image by simple concatenation or weighted sum of embedding vectors generated by the vision encoder and the text encoder.

In an example, the second model may include a multimodal model trained to extract feature information by processing data of an arbitrary input modality (e.g., an image or text) and convert the extracted feature information into an embedding vector of a high-dimensional space. The second model may generate embedding vectors for the image query, the text query, and each candidate image of the candidate image set through the multimodal model. The second model may generate the multimodal feature information corresponding to each candidate image by simple concatenation or weighted sum of embedding vectors generated through the multimodal model. In an example, the second model may be trained to generate a cross-modality embedding that includes interaction information between inputs for data inputs of multiple modalities. The second model may generate the cross-modality embedding for the image query, the text query, and each candidate image of the candidate image set as the multimodal feature information.

The second model may determine the multimodal score for each candidate image of the candidate image set based on the multimodal feature information described above. The multimodal score for each candidate image of the candidate image set may be a result of quantifying a similarity (or relevance) between the query (in other words, the image query and the text query) and each candidate image using the multimodal feature information corresponding to each candidate image.

The electronic device may generate the multimodal score for the candidate image set using the second model. The multimodal score may include the multimodal score of each candidate image of the candidate image set.

In an example, in operation 440, the electronic device (e.g., electronic device 300) may determine one or more target images from the candidate image set based on the multimodal score for the candidate image set.

The target image may indicate an image that is highly relevant (or similar) to the image query and is returned as a retrieval result for the image query.

The electronic device may determine one or more target images with highest multimodal scores from the candidate image set. The electronic device may rank the candidate images of the candidate image set based on the multimodal scores. The electronic device may rank the candidate images of the candidate image set in descending order based on corresponding multimodal scores. For example, the electronic device may determine a defined (or predetermined) number of candidate images with highest multimodal scores from the candidate image set to be the one or more target images.

In an example, the electronic device may include an LLM. For example, the memory 320 of FIG. 3 may store the LLM. The electronic device may generate a response for the image query using at least a portion of the one or more target images. The electronic device may generate a response using at least a portion of one or more target images retrieved from the database with the user query (e.g., the image query) through the LLM. The electronic device may output the generated response. For example, the electronic device may transmit the response to the user terminal that receives the user query.

FIG. 5 illustrates an example method with obtaining a multimodal retrieval result according to one or more embodiments.

Referring to FIG. 5, in a non-limiting example, in method 500 may include operations 510 to 530 which, as described below, may be performed by an electronic device (e.g., the electronic device 300 of FIG. 3). That is, the electronic device that performs the method 500 may include at least some of the components of the electronic device 300 described above with reference to FIG. 3. For example, the electronic device may include at least one processor (e.g., the at least one processor 310 of FIG. 3) including a processing circuitry. The electronic device may include a memory (e.g., the memory 320 of FIG. 3) including one or more storage media storing instructions. Furthermore, the electronic device may include a trained first model (e.g., the first model 10 of FIG. 1 or the first model 20 of FIG. 2). The electronic device may also include a trained second model (e.g., the second model 12 of FIG. 1).

In an example, referring to operation 420 from FIG. 4 of obtaining one or more images as the first retrieval result and one or more texts as the second retrieval result may include operations 510 to 530. Referring to FIG. 5, operations 520 and 530 may be sequentially performed, but this is an example and operations 520 and 530 may be instead performed in parallel.

In an example, in operation 510, the electronic device (e.g., electronic device 300) may generate a first embedding vector by performing embedding on an image query. The electronic device may generate a second embedding vector by performing embedding on a text query.

In an example, as described above with reference to FIG. 3, the electronic device may include a vision encoder. The electronic device may generate the first embedding vector by performing embedding on the image query using the vision encoder. The vision encoder may extract feature information (e.g., a shape, texture, a pattern, etc.) by processing the input image query and may convert the extracted feature information into the first embedding vector in a high-dimensional space.

In addition, with reference to FIG. 3, the electronic device may include a text encoder. The electronic device may generate the second embedding vector by performing embedding on the text query using the text encoder. The text encoder may extract feature information (e.g., a grammatical structure, a relation between words, semantic information, etc.) by processing the input text query and may convert the extracted feature information into the second embedding vector in a high-dimensional space.

In an example, as described above with reference to FIG. 3, the electronic device may include a multimodal model trained to extract the feature information by processing data of an arbitrary input modality (e.g., an image or text) and convert the extracted feature information into a high-dimensional embedding vector. The electronic device may generate the first embedding vector by performing embedding on the image query using the multimodal model. The electronic device may generate the second embedding vector by performing embedding on the text query using the multimodal model.

In addition, as further described above with reference FIG. 2 above, a database (e.g., the database 11 of FIG. 1 or the database 21 of FIG. 2) may include an image database (e.g., the image database 211 of FIG. 2) and a text database (e.g., the text database 213 of FIG. 2). The text database may include texts respectively corresponding to images included in the image database.

Referring back to FIG. 5, in operation 520, in an example, the electronic device (e.g., electronic device 300) may obtain one or more images from the database as a first retrieval result based on a comparison between the first embedding vector and embedding vectors indexed to the images included in the database (e.g., the image database).

The electronic device may determine first scores of the images by comparing the first embedding vector for the image query with the embedding vectors indexed to the images included in the database (e.g., the image database).

The electronic device may determine the first score indicating a similarity (or relevance) between the first embedding vector for the image query with the embedding vectors indexed to the images included in the database. For example, the electronic device may determine a cosine similarity between the first embedding vector for the image query and the embedding vectors indexed to the images included in the database to be the first score. For example, the electronic device may determine the first score based on a Euclidean distance between the first embedding vector for the image query and the embedding vectors indexed to the images included in the database. The electronic device may determine the Euclidean distance to be the first score or may determine the reverse of the Euclidean distance or a normalized value of the Euclidean distance for the images included in the database to be the first score. The first score may include respective scores of the images included in the database.

The electronic device may obtain, from the database, one or more images having corresponding scores that satisfy a defined (or predetermined) condition as the first retrieval result, based on the first scores of the images. For example, the electronic device may obtain one or more images that have corresponding scores which are greater than or equal to (or exceed) a threshold value as the first retrieval result from the images included in the database. For example, the electronic device may obtain a defined (or predetermined) number of images having their corresponding scores be greater than or equal to (or exceed) a threshold value as the first retrieval result from the images included in the database.

However, the example described above may apply to a case in which the first score is proportional to the similarity between the first embedding vector for the image query and the embedding vectors indexed to the images included in the database (e.g., when the first score is a cosine similarity, the reverse of a Euclidean distance, or a normalized value of the Euclidean distance). When the first score is inversely proportional to a first similarity between the first embedding vector for the image query and the embedding vectors indexed to the images included in the database (e.g., when the first score is a Euclidean distance), the electronic device may obtain one or more images having their corresponding scores be less than (or less than or equal to) a threshold value from the images included in the database as the first retrieval result.

In an example, in operation 530, the electronic device (e.g., electronic device 300) may obtain one or more texts from the database as a second retrieval result based on a comparison between the second embedding vector and embedding vectors indexed to the texts included in the database (e.g., the text database).

The electronic device may determine second scores of the texts by comparing the second embedding vector for the text query with embedding vectors indexed to the texts included in the database (e.g., the text database).

The electronic device may determine the second score indicating a similarity between the second embedding vector for the text query and the embedding vectors indexed to the texts included in the database. For example, the electronic device may determine a cosine similarity between the second embedding vector for the text query and the embedding vectors indexed to the texts included in the database to be the second score. For example, the electronic device may determine the second score based on a Euclidean distance between the second embedding vector for the text query and the embedding vectors indexed to the texts included in the database. The electronic device may determine the Euclidean distance to be the second score or may determine the reverse of the Euclidean distance or a normalized value of the Euclidean distance for the texts included in the database to be the second score. The second score may include respective scores of the texts included in the database.

The electronic device may obtain, from the database, one or more texts having corresponding scores that satisfy a defined (or predetermined) condition as the second retrieval result, based on the second scores of the texts. For example, the electronic device may obtain one or more texts having their corresponding scores be greater than or equal to (or exceed) a threshold value as the second retrieval result from the texts included in the database. For example, the electronic device may obtain a defined (or predetermined) number of texts having corresponding scores that are greater than or equal to (or exceed) a threshold value as the second retrieval result from the texts included in the database.

However, the example described above may apply to a case in which the second score is proportional to the similarity between the second embedding vector for the text query and the embedding vectors indexed to the texts included in the database (e.g., when the second score is a cosine similarity, the reverse of a Euclidean distance, or a normalized value of the Euclidean distance). When the second score is inversely proportional to a second similarity between the second embedding vector for the text query and the embedding vectors indexed to the texts included in the database (e.g., when the second score is a Euclidean distance), the electronic device may obtain one or more texts with corresponding scores less than (or less than or equal to) a threshold value from the texts included in the database as the second retrieval result.

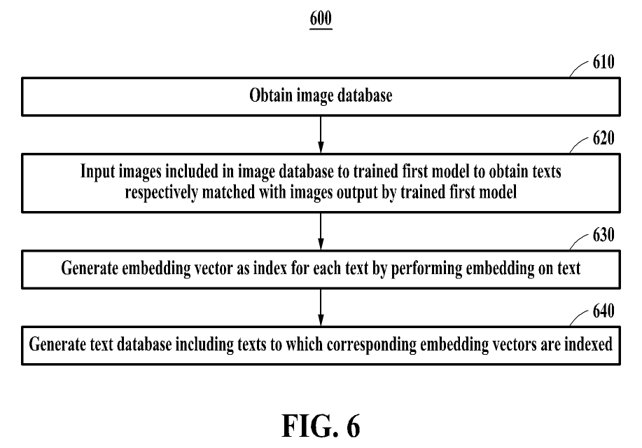

FIG. 6 illustrates an example method with database establishment according to one or more embodiments.

Referring to FIG. 6, in a non-limiting example, method 600 may include operations 610 to 640 which, as described below, may be performed by an electronic device (e.g., the electronic device 300 of FIG. 3). For example, the electronic device performing method 600 may include at least some of the components of the electronic device 300 described with reference to FIG. 3. For example, the electronic device may include at least one processor (e.g., the at least one processor 310 of FIG. 3) including a processing circuitry. The electronic device may include a memory (e.g., the memory 320 of FIG. 3) including one or more storage media storing instructions. The electronic device may include a trained first model (e.g., the first model 10 of FIG. 1 or the first model 20 of FIG. 2). In addition, the electronic device may include a trained second model (e.g., the second model 12 of FIG. 1).

In an example, operations 610 to 640 may be performed prior to operation 410 of FIG. 4.

In an example, in operation 610, the electronic device (e.g., electronic device 300) may obtain an image database (e.g., the image database 211 of FIG. 2).

In an example, as described above with reference to FIG. 2, the electronic device may obtain images (e.g., the image set 210 of FIG. 2).

In an example, the images obtained by the electronic device may include an embedding vector indexed to each of the images. The electronic device may store the images, to which corresponding embedding vectors are indexed, in the image database.

The electronic device may generate an embedding vector as an index for each of the images by performing embedding on the images. The electronic device may store the images, to which corresponding embedding vectors are indexed, in the image database. This may be construed as building the image database based on the images to which corresponding embedding vectors are indexed.

In an example, in operation 620, the electronic device (e.g., electronic device 300) may input images included in the image database to a trained first model to obtain texts respectively matched with (or corresponding to) the images output by the trained first model.

The electronic device may generate texts describing (i.e., explaining, summarizing, captioning, or interpreting) the images included in the image database, respectively, using the first model. Each text may indicate one or more words related to an object or a feature in each image included in the image database. Each text may be a phrase, a clause, or multiple sentences.

In an example, in operation 630, the electronic device (e.g., electronic device 300) may generate an embedding vector as an index for each text by performing embedding on the text.

In an example, as described above with reference to FIG. 3, the electronic device may include a text encoder. The electronic device may generate an embedding vector as an index for each of the texts by performing embedding on the texts using the text encoder.

In an example, as also described above with reference to FIG. 3, the electronic device may include a multimodal model trained to extract the feature information by processing data of an arbitrary input modality (e.g., an image or text) and convert the extracted feature information into a high-dimensional embedding vector. The electronic device may generate an embedding vector as an index for each text by performing embedding on the text using the multimodal model.

In an example, in operation 640, the electronic device (e.g., electronic device 300) may generate a text database (e.g., the text database 213 of FIG. 2) including the texts to which corresponding embedding vectors are respectively indexed. This may be construed as building the text database based on the texts to which corresponding embedding vectors are indexed.

The electronic device may store the text database. The electronic device may store the image database and the text database described above as a database (e.g., the database 11 of FIG. 1 or the database 21 of FIG. 2).

The neural networks, electronic devices, memories, processors, databases, database 11, first and second models 10 and 12, electronic device 200, electronic device 300, at least one processor 310, and memory 320 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special- purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a text query based on an image query by inputting the image query to a trained first model;
obtaining, from a database, one or more images as a first retrieval result for the image query and one or more texts as a second retrieval result for the text query;
generating a multimodal score for a candidate image set by inputting, to a trained second model, the image query, the text query, and the candidate image set determined based on the first retrieval result and the second retrieval result; and
determining one or more target images from the candidate image set based on the multimodal score for the candidate image set.

2. The method of claim 1, wherein the database comprises an image database and a text database, and
wherein the text database includes texts respectively matched with images included in the image database.

3. The method of claim 1, wherein the obtaining of the one or more images comprises:
generating a first embedding vector by performing embedding on the image query and a second embedding vector by performing embedding on the text query;
obtaining the first retrieval result based on a first comparison between the first embedding vector and embedding vectors indexed to the images included in the database; and
obtaining the second retrieval result based on a second comparison between the second embedding vector and embedding vectors indexed to the texts included in the database.

4. The method of claim 3, wherein the obtaining of the one or more images as the first retrieval result comprises:
determining first scores of the images by comparing the first embedding vector with the embedding vectors indexed to the images included in the database; and
obtaining the one or more images as the first retrieval result based on respective first scores of the images satisfying a defined condition.

5. The method of claim 3, wherein the obtaining of the one or more texts as the second retrieval result comprises:
determining second scores of the texts by comparing the second embedding vector with the embedding vectors indexed to the texts included in the database; and
obtaining the one or more texts satisfying a defined condition as the second retrieval result, based on the second scores of the texts.

6. The method of claim 1, wherein the candidate image set includes the one or more images obtained as the first retrieval result and one or more images matched with the one or more texts obtained as the second retrieval result.

7. The method of claim 1, wherein the trained second model is pre-trained to output a multimodal score for each candidate image based on the image query, the text query, and multimodal feature information on each candidate image of the candidate image set.

8. The method of claim 1, wherein the determining of the one or more target images from the candidate image set comprises:
determining a defined number of candidate images with highest multimodal scores as the one or more target images from the candidate image set.

9. The method of claim 1, further comprising:
obtaining an image database;
inputting images included in the image database to the trained first model to obtain texts;
generating an embedding vector as an index for each of the texts by performing embedding on the texts; and
generating a text database including the texts to which corresponding embedding vectors are respectively indexed.

10. The method of claim 1, further comprising:
generating a response to the image query by using at least a portion of the one or more target images.

11. A non-transitory computer-readable storage medium that stores one or more programs comprising instructions, wherein the instructions, when executed individually or collectively by at least one processor of an electronic device, cause the electronic device to:
generate a text query based on an image query by inputting the image query to a trained first model,
obtain, from a database, one or more images as a first retrieval result for the image query and one or more texts as a second retrieval result for the text query,
generate a multimodal score for a candidate image set by inputting, to a trained second model, the image query, the text query, and the candidate image set determined based on the first retrieval result and the second retrieval result, and
determine one or more target images from the candidate image set based on the multimodal score for the candidate image set.

12. An electronic device comprising:
at least one processor; and
memory comprising one or more storage media storing instructions,
wherein the instructions, when executed individually or collectively by the at least one processor, cause the electronic device to perform:
generating a text query based on an image query by inputting the image query to a trained first model;
obtaining, from a database, one or more images as a first retrieval result for the image query and one or more texts as a second retrieval result for the text query;
generating a multimodal score for a candidate image set by inputting, to a trained second model, the image query, the text query, and the candidate image set determined based on the first retrieval result and the second retrieval result; and
determining one or more target images from the candidate image set based on the multimodal score for the candidate image set.

13. The electronic device of claim 12, wherein the database comprises an image database and a text database, and
wherein the text database includes texts respectively matched with images included in the image database.

14. The electronic device of claim 12, wherein the obtaining of the one or more images as the first retrieval result comprises:
generating a first embedding vector by performing embedding on the image query and a second embedding vector by performing embedding on the text query;
obtaining the first retrieval result based on a first comparison between the first embedding vector and embedding vectors indexed to the images included in the database; and
obtaining the second retrieval result based on a second comparison between the second embedding vector and embedding vectors indexed to the texts included in the database.

15. The electronic device of claim 14, wherein the obtaining of the one or more images as the first retrieval result comprises:
determining first scores of the images by comparing the first embedding vector with the embedding vectors indexed to the images included in the database; and
obtaining the one or more images as the first retrieval result based on respective first scores of the images satisfying a defined condition.

16. The electronic device of claim 14, wherein the obtaining of the one or more texts as the second retrieval result comprises:
determining second scores of the texts by comparing the second embedding vector with the embedding vectors indexed to the texts included in the database; and
obtaining the one or more texts satisfying a defined condition as the second retrieval result, based on the second scores of the texts.

17. The electronic device of claim 12, wherein the candidate image set includes the one or more images obtained as the first retrieval result and one or more images matched with the one or more texts obtained as the second retrieval result.

18. The electronic device of claim 12, wherein the trained second model is pre-trained to output a multimodal score for each candidate image based on the image query, the text query, and multimodal feature information on each candidate image of the candidate image set.

19. The electronic device of claim 12, wherein the determining of the one or more target images from the candidate image set comprises:
determining a defined number of candidate images with highest multimodal scores as the one or more target images from the candidate image set.

20. The electronic device of claim 12, wherein the instructions, when executed individually or collectively by the at least one processor, further cause the electronic device to perform:
generating a response to the image query by using at least a portion of the one or more target images.
